(19) United States
(12) Patent Application Publication
(10) Pub. No.: US 2002/0176949 A1
(43) Pub. Date: Nov. 28, 2002

(54) Fragrance keeping material

(76) Inventors: Kazuo Hokkirigawa, Yonezawa-shi (JP); Noriyuki Yoshimura, Nagano-ken (JP); Motoharu Akiyama, Nagano-ken (JP)

Correspondence Address: FLYNN, THIEL, BOUTELL & TANIS, P.C., 2026 Rambling Road, Kalamazoo, MI, 49008-1699, US

(21) Appl. No.: 10/154,794

(22) Filed: May 24, 2002

(30) Foreign Application Priority Data
May 25, 2001 (JP) 2001-157539

(51) Int. Cl. B32B 1/02

(52) U.S. Cl. 428/34.1; 428/402; 428/321.1; 428/307.3

(57) ABSTRACT

There is provided a fragrance keeping material capable of molding into free shapes in which RB ceramics and/or CRB ceramics of 10 to 2,000 angstrom in pore diameter and 0.1 to 1.1 cm³/g in pore volume is used to keep or absorb a fragrance.

### FIELD OF THE INVENTION

This invention relates to a fragrance keeping material and a fragrance container which emits the fragrance effectively.

### BACKGROUND OF THE INVENTION

Various kinds of fragrant products have been produced and sold with recent rise in consumer's sense and requirements for fragrance.

Such fragrant products are classified into two groups, i.e., gel-type and liquid-type.

The gel-type fragrance is further divided into an independent composition which comprises polysaccharide as a gelling base material such as agar, carrageenan and gums and a dependent composition which comprises water absorbing resins. The independent composition is excellent in relatively low production cost and visual appearance in use as well as on termination of use due to a decrease in volume thereof and less occurrence of liquid leakage. However, it is a problem of this composition that a vaporizing surface area decreases with gradual reduction of volume thereof due to evaporation so that intensity of fragrance is getting low toward termination of use.

On the other hand, as the dependent composition is fluid and usually kept in a cup-like container, its vaporizing surface area seldom decreases with the elapse of time, while the level of vaporizing surface goes down in the container with a decrease in the composition, which causes insufficient aeration and slow-down of vaporization. As a result, intensity of fragrance is inconveniently decreased on the termination of use. It is also a problem of this type that the dependent base material is fluid and would split out of the container when it is overturned.

A variety of liquid type fragrant products are also manufactured and on sale widely. Most of them are provided with a wick or thin pipe and a plate to vaporize the agent. Vaporization of this type is kept relatively constant compared with that of gel type because of no decrease in or lowering of the vaporizing surface. However, as there is a risk of leaking liquid at all times, it is necessary to carry them carefully to prevent them from overturning.

### SUMMARY OF THE INVENTION

Accordingly, it is an object of the present invention to provide a fragrance keeping material and a fragrance container for keeping a liquid type fragrance without leaking of liquid even if the container is overturned.

As a result of concentrated investigation, the inventors have found that a fragrance keeping material and a fragrance container without leaking of liquid even if the container is overturned can be provided by adsorbing a fragrance to a molded material or a powder of porous RB ceramics and/or porous CRB ceramics.

### BRIEF DESCRIPTION OF THE DRAWINGS

FIG. 1a is an illustration of a relatively large pore of CRB ceramics;

FIG. 1b is an illustration of pores of CRB ceramics caused by rice bran;

FIG. 1c is an illustration of pores of CRB ceramics caused by polymer chain;

FIG. 2 is a sketch and a sectional view of ornamental pot made of a fragrance keeping material of the present invention; and

FIG. 3 is a sketch of an ornament of artificial flower with a fragrance keeping material of the present invention.

### PREFERRED EMBODIMENTS OF THE INVENTION

A porous RB ceramics and/or porous CRB ceramics material used in the present invention is prepared from a defatted product of rice bran as a main raw material and a thermosetting resin.

As is known, Dr. Kazuo Hokkirigawa, the first inventor of the present invention, proposed an idea to obtain a porous carbon material by the use of rice bran which is by-produced 0.9 million ton/year in Japan or 3.3 million ton/year in the world (see, Kinou Zairyou, Vol. 17, No. 5, pp. 24 to 28, May 1997).

The above mentioned literature describes a method for preparing a carbon material or so-called RB ceramics by mixing and kneading a defatted product of rice bran and a thermosetting resin, press-molding the mixture to form a molded material, drying and then baking the dried material in an atmosphere of inert gas.

Defatted rice bran used in the present invention is not limited to a specific species of rice and may either be a product of Japan or foreign countries.

A thermosetting resin used herein may also be any resin which can be thermally set and typically includes phenol-, diarylphthalate-, unsaturated polyester-, epoxy-, polyimide- and triazine resins, although a phenol resin is preferably used.

A thermoplastic resin such as polyamide may also be used together without departing from a scope of the present invention.

A mixing ratio of the defatted rice bran to the thermosetting resin is in the range of 50 to 90:50 to 10 and preferably 70 to 80:30 to 20 by weight.

According to the above mentioned method, difference in ratio of shrinkage between the press-molded material and the finally molded material which is baked in an atmosphere of inert gas reached almost 25%. Such a difference made it substantially difficult to form a precisely molded material, but has been finally improved as a result of development of CRB ceramics.

Porous CRB ceramics used in the present invention is an improved material of RB ceramics obtained from defatted rice bran and a thermosetting resin and is prepared by mixing and kneading both of these materials. The defatted product of rice bran and the thermosetting resin are mixed and kneaded, primarily baked in an inert gas at 700 to 1,000° C. and ground to form a carbonated powder of about 60 mesh or less. The powder is then mixed and kneaded with the thermosetting resin to yield a mixture (hereinafter referred to as a CRB precursor), press-molded at a pressure of 20 to 30 Mpa and further heat-treated the thus molded material in an atmosphere of inert gas at 500 to 1,100° C. to form CRB ceramics as a molded product.

CRB ceramics is a porous material having innumerable pores. These pores formed in CRB ceramics can be classified into three kinds of types depending on a formation process thereof.

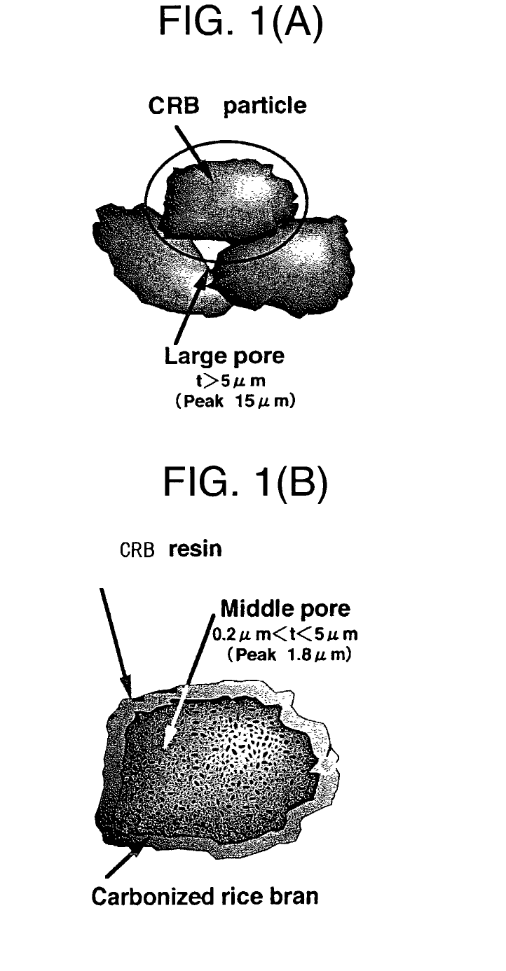

A pore shown in FIG. 1(a) is relatively large one having a pore diameter of 5 μm or more, which is formed as a space between CRB fine particles when they overlap each other. A peak pore value of this type is about 15 μm.

What is shown in FIG. 1(b) is a pore having a pore diameter of less than 5 μm which is formed by fiber structure caused by rice bran. A peak pore value of this type is about 1.8 μm.

A pore shown in FIG. 1(c) is a small one having a pore diameter of 0.2 μm or less which is formed as a space between molecular chains of high molecular polymer such as a phenol resin when the polymer is carbonated at high temperature. A peak pore value of this type is about 0.05 μm.

The thus formed three kinds of pores of CRB ceramics function as a fragrance keeping material corresponding to each pore diameter, respectively.

The most typical distinction of RB ceramics and CRB ceramics is that a difference in ratio of shrinkage between molded RB ceramics and a final product thereof is almost 25%, while that of CRB ceramics is so low as 3% or less, which makes the latter material much useful.

General properties of RB ceramics and CRB ceramics are as in the following:

extremely high hardness;

extremely small heat expansion coefficient;

porous structure;

electrical conductivity;

low specific gravity, light weighted;

improved abrasion resistance;

easiness of molding and mold die making;

capable of being powdered; and

less negative effect to global environment and more resource conservation due to rice bran to be used as a starting material.

Accordingly, when a fragrance container is prepared as a molded product of ornament directly from porous RB ceramics and/or porous CRB ceramics as a molded material, it is suitable to use CRB ceramics because of its precise moldability. However, even in the above mentioned case, RB ceramics should not be excluded from embodiments of the present invention, because it is possible to mold RB ceramics by means of a little bit larger mold die, which is then reduced to a desired size through secondary processing.

Porosity of porous RB ceramics and/or porous CRB ceramics can be controlled by changing baking conditions, which is one of characteristic features of these materials.

It is generally confirmed that such porosity is increased with an increase in heat-treating temperature.

When a fragrant containing material is prepared as a molded product directly from porous RB ceramics and/or porous CRB ceramics according to the present invention, the molded product suitably has a pore diameter of 10 to 2,000 angstrom and a pore volume of 0.1 to 1.1 cm³/g.

When porous RB ceramics and/or porous CRB ceramics is used in the present invention, it is not necessary to consider a difference in shrinkage between RB ceramics and CRB ceramics so that basically either of these powdery materials may be used on an equal footing. Particle size of a RB ceramics or CRB ceramics powder varies depending on the purpose to be used, although an average particle diameter of 0.1 to 1,000 μm is generally used.

Porosity is an important factor of porous RB ceramics and/or porous CRB ceramics used in the present invention, which is influenced by the primary baking temperature of RB ceramics and by both of the primary baking temperature and the secondary heat-treating temperature of CRB ceramics.

RB ceramics or CRB ceramics of optimum porosity can be yielded by primary baking or secondary heat treatment thereof at a temperature of 800 to 1,000° C.

When porous RB ceramics and/or porous CRB ceramics is used as a powder, a well-known carbon fine powder may be used together with the ceramics powder.

A ratio of the powder of RB ceramics and/or CRB ceramics to the carbon powder is suitably 50 to 90:50 to 10 by weight.

The powder of RB ceramics or CRB ceramics is hard, while its surface is quite rough, which characteristically increases maintaining properties thereof as a powdery material.

Embodiments of the present invention will be summarised as in the following.

1. A fragrance keeping material in which a fragrance is adsorbed to a molded product of porous RB ceramics material and/or porous CRB ceramics.

2. A fragrance keeping material described in the above item 1 in which a molded material is a spherical body of 1 to 20 mm in diameter.

3. A fragrance keeping material described in the above item 1 in which a molded material is a cubic body of 1 to 20 mm in side.

4. A fragrance keeping material described in the above item 1 in which a molded material is a tablet-like body of 5 to 20 mm in diameter.

5. A fragrance keeping material described in the above item 1 in which a molded material is a cylindrical body of 1 to 20 mm in diameter and 1 to 20 mm in length.

6. A fragrance container in which a molded product described in either one of the above items 2 to 5 is put is a fragrance container provided with an openable and closable lid.

7. A fragrance container described in the above item 6 in which the fragrance container is an ornamental model.

8. A fragrance keeping material described in the above item 1 in which a molded product is an ornamental model.

9. A fragrance keeping material in which a fragrance is adsorbed to a powder of porous RB ceramics material and/or porous CRB ceramics.

10. A fragrance container in which a powder described in the above item 9 is put is a fragrance container provided with a openable and closeable lid.

11. A fragrance container described in the above item 10 in which the container is an ornamental model.

It has been found that a fragrance keeping material of the present invention can be molded into free shapes while keeping predetermined properties due to the use of RB ceramics and CRB ceramics. It has been also found that a powder of RB ceramics and CRB ceramics exhibits suitable properties as a fragrance keeping material.

This invention will be further described in the following examples.

### EXAMPLE 1

Preparation of CRB ceramics precursor

A defatted product of rice bran in an amount of 75 kg and a liquid phenol resin (resol) in an amount of 25 kg were mixed and kneaded by heating at 50 to 60° C. to form a plastic and homogeneous mixture.

The mixture was primarily baked by means of a rotary kiln in a nitrogen atmosphere at 900° C. for 60 minutes. The carbonated material thus baked was screened through a 100-mesh screen to form a carbonated powder of 50 to 250 μm in particle diameter.

The carbonated powder in an amount of 75 kg and a solid phenol resin (resol) in an amount of 25 kg were mixed and kneaded by heating at 100 to 150° C. to form a plastic and homogeneous mixture as a plastic CRB ceramics precursor.

Molding of a fragrance keeping material

Then, there was made a mold die for molding a spherical body of 10.0 cm in diameter, to which the plastic CRB ceramics precursor was pored and press-molded at a pressure of 22 Mpa. The mold die temperature was 150° C.

The thus molded body was taken out of the mold die and subjected to a heat treatment by heating-up to 500° C. in a nitrogen atmosphere at a heat rising rate of 1° C. per minute and keeping at 500° C. for 60 minutes and then at 900° C. for about 60 minutes.

The molded body was then cooled at a cool down rate of 2 to 3° C. per minute down to 500° C., followed by natural heat dissipation under 500° C. to yield a molded spherical body 1 of CRB ceramics.

Properties of the fragrance keeping material

The molded spherical body of CRB ceramics showed an average pore diameter of 550 angstrom and a pore volume of 0.45 cm³/g, and absorbed a fragrance well.

### EXAMPLE 2

Preparation of CRB ceramics precursor

A defatted product of rice bran in an amount of 75 kg and a liquid phenol resin (resol) in an amount of 25 kg were mixed and kneaded by heating at 50 to 60° C. to form a plastic and homogeneous mixture.

The mixture was primarily baked by means of a rotary kiln in a nitrogen atmosphere at 900° C. for 60 minutes. The carbonated material thus baked was screened through a 200-mesh screen to form a carbonated powder of 50 to 120 μm in particle diameter.

The carbonated powder in an amount of 75 kg and a solid phenol resin (resol) in an amount of 25 kg were mixed and kneaded by heating at 100 to 150° C. to form a plastic and homogeneous mixture as a plastic CRB ceramics precursor.

Molding of a fragrance keeping material

Then, there was made a mold die for molding a cubic body of 2 cm in side, to which the plastic CRB ceramics precursor was pored and press-molded at a pressure of 25 Mpa. The mold die temperature was 150° C.

The thus molded body was taken out of the mold die and subjected to a heat treatment by heating-up to 500° C. in a nitrogen atmosphere at a heat rising rate of 1° C. per minute and keeping at 500° C. for 60 minutes and then at 1,000° C. for about 150 minutes.

The molded body was then cooled at a cool down rate of 2 to 3° C. per minute down to 500° C., followed by natural heat dissipation under 500° C. to yield a molded cubic body 2 of CRB ceramics.

Properties of the fragrance keeping material

The molded product 2 of CRB ceramics 1 showed an average pore diameter of 380 angstrom and a pore volume of 0.52 cm³/g, and absorbed a fragrance well.

### EXAMPLE 3

Preparation of RB ceramics precursor

A defatted product of rice bran in an amount of 75 kg and a liquid phenol resin (resol) in an amount of 25 kg were mixed and kneaded by heating at 50 to 60° C. to form a plastic and homogeneous mixture.

Molding of a fragrance keeping material

Then, there was made a mold die for molding a spherical body of 1.0 cm in diameter similarly as Example 1, to which the plastic RB ceramics precursor was pored and press-molded at a pressure of 22 Mpa. The mold die temperature was 170° C.

The thus molded body was taken out of the mold die and subjected to a heat treatment by heating-up to 500° C. in a nitrogen atmosphere at a heat rising rate of 1° C. per minute and keeping at 800° C. for 120 minutes. The molded body was then cooled at a cool down rate of 2 to 3° C. per minute down to 500° C., followed by natural heat dissipation under 500° C.

Properties of the fragrance keeping material

The molded spherical body of RB ceramics 1 showed an average pore diameter of 450 angstrom and a pore volume of 0.50 cm³ /g, and absorbed a fragrance well although it shrank slightly.

### EXAMPLE 4

Preparation of CRB ceramics precursor

A defatted product of rice bran in an amount of 75 kg and a liquid phenol resin (resol) in an amount of 25 kg were mixed and kneaded by heating at 50 to 60° C. to form a plastic and homogeneous mixture.

The mixture was primarily baked by means of a rotary kiln in a nitrogen atmosphere at 900° C. for 60 minutes. The carbonated material thus baked was screened through a 300-mesh screen to form a carbonated powder of 50 to 80 μm in particle diameter.

The carbonated powder in an amount of 78 kg and a solid phenol resin (resol) in an amount of 22 kg were mixed and kneaded by heating at 100 to 150° C. to form a plastic and homogeneous mixture as a plastic CRB ceramics precursor.

Molding of a fragrance keeping material

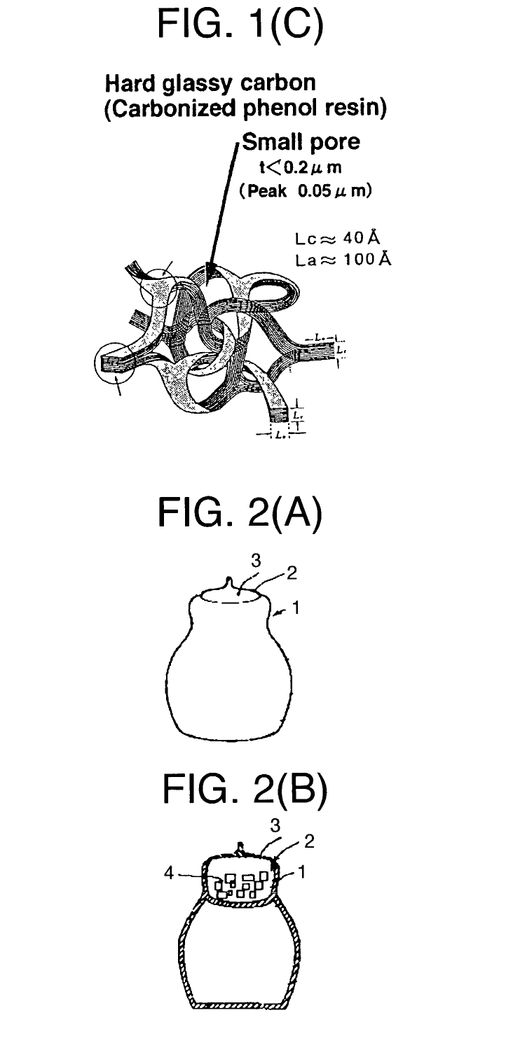

Then, there was made a mold die for molding an ornamental pot 1 having a lid 2 with a perforation 3 as shown in FIG. 2, to which the plastic CRB ceramics precursor was pored and press-molded at a pressure of 22 Mpa. The mold die temperature was 150° C.

The thus molded body was taken out of the mold die and subjected to a heat treatment by heating-up to 500° C. in a nitrogen atmosphere at a heat rising rate of 1° C. per minute and keeping at 500° C. for 60 minutes and then at 1,000° C. for about 120 minutes.

The molded body was then cooled at a cool down rate of 2 to 3° C. per minute down to 500° C., followed by natural heat dissipation under 500° C. to yield a molded product 1 of CRB ceramics as shown in FIG. 2.

Properties of the fragrance keeping material

The molded ornamental pot 1 of CRB ceramics showed an average pore diameter of 390 angstrom and a pore volume of 0.55 cm³ /g, and absorbed a fragrance well. The fragrance was successfully kept throughout the pot itself by directly impregnating the fragrance into the pot.

### EXAMPLE 5

Preparation of CRB ceramics precursor

A defatted product of rice bran in an amount of 75 kg and a liquid phenol resin (resol) in an amount of 25 kg were mixed and kneaded by heating at 50 to 60° C. to form a plastic and homogeneous mixture.

The mixture was primarily baked by means of a rotary kiln in a nitrogen atmosphere at 900° C. for 60 minutes. The carbonated material thus baked was ground by means of a grinder and screened through a 200-mesh screen to form a carbonated powder of 50 to 130 μm in particle diameter.

The carbonated powder in an amount of 75 kg and a solid phenol resin (resol) in an amount of 25 kg were mixed and kneaded by heating at 100 to 150° C. to form a plastic and homogeneous mixture.

Preparation of a powder

The plastic mixture was then press-molded at a pressure of 20 Mpa to form a spherical body of 3 cm in diameter. The mold die temperature was 150° C.

The thus molded body was taken out of the mold die and subjected to a heat treatment by heating-up to 500° C. in a nitrogen atmosphere at a heat rising rate of 1° C. per minute and keeping at 500° C. for 60 minutes and sintering at 950° C. for about 120 minutes.

The molded body was then cooled at a cool down rate of 2 to 3° C. per minute down to 500° C., followed by natural heat dissipation under 500° C.

The spherical body of 3 cm in diameter was ground by means of a grinder and further finely ground by means of a ball mill to form CRB ceramics fine particles of 5 to 10 μm in average particle diameter.

Properties of the powdery fragrance keeping material

The RB ceramics fine particles of 7 μm in average particle diameter showed a pore volume of 0.53 cm³/g, and absorbed a fragrance well.

### EXAMPLE 6

A fragrance was impregnated into fragrance keeping materials 4, which were prepared in Examples 1 to 3, and a proper number of pieces thereof were put in a pot 1 having a lid 2 with a perforation 3, which was prepared in Example 4, after taking off the lid 2.

It is possible to change a fragrance keeping material to new one when the fragrance is faded therefrom.

It is also possible to activate a used fragrance keeping material with steam, etc. and further impregnate a fragrance into the material for recycling use.

### EXAMPLE 7

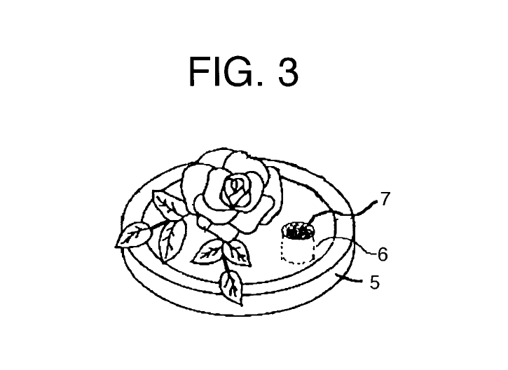

As shown in FIG. 3, a base part 5 of artificial flower ornament was bored to form a cylindrical space 6, while a fine powdery fragrance keeping material 7 prepared in Example 5 was impregnated with a fragrance and packed in the space.

The fragrance may be changed depending on the kind of an artificial flower to be decorated. A perforated lid, not shown in FIG. 3, may be put on the cylindrical space 6.

It is possible to change the fragrance keeping material to new one when the fragrance is faded, and to reuse the material for recycling similarly as in the case of Example 6.

What is claimed is:

1. A fragrance keeping material in which a fragrance is adsorbed to a molded product of porous RB ceramics material and/or porous CRB ceramics.

2. A fragrance keeping material claimed in claim 1 in which a molded material is a spherical body of 1 to 20 mm in diameter.

3. A fragrance keeping material claimed in claim 1 in which a molded material is a cubic body of 1 to 20 mm in side.

4. A fragrance keeping material claimed in claim 1 in which a molded material is a tablet-like body of 5 to 20 mm in diameter.

5. A fragrance keeping material claimed in claim 1 in which a molded material is a cylindrical body of 1 to 20 mm in diameter and 1 to 20 mm in length.

6. A fragrance container in which a molded product claimed in either one of claims 2 to 5 is put is a fragrance container provided with an openable and closable lid.

7. A fragrance container claimed in claim 6 in which the fragrance container is an ornamental model.

8. A fragrance keeping material claimed in claim 1 in which a molded product is an ornamental model.

9. A fragrance keeping material in which a fragrance is adsorbed to a powder of porous RB ceramics material and/or porous CRB ceramics.

10. A fragrance container in which a powder claimed in claim 9 is put is a fragrance container provided with an openable and closable lid.

11. A fragrance container claimed in claim 10 in which the container is an ornamental model.
